(19) United States
(12) Patent Application Publication
(10) Pub. No.: US 2006/0119715 A1
(43) Pub. Date: Jun. 8, 2006

(54) CMOS image sensor sharing readout circuits between adjacent pixels

(75) Inventor: Jung-Hyun Nam, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/291,218

(22) Filed: Dec. 1, 2005

(30) Foreign Application Priority Data
Dec. 3, 2004 (KR) 10-2004-0101140

(51) Int. Cl. H04N 9/04

(52) U.S. Cl. 348/272

(57) ABSTRACT

A CMOS image sensor includes first pairs of light-receiving elements sharing an output circuit and second pairs of light-receiving elements sharing an output circuit arranged in a first direction forming a first row and a second row respectively, wherein the first pairs include respective a first and a second light-receiving element and the second pairs include a third and a fourth light-receiving element. A plurality of the first rows and a plurality of second rows are interlaced, wherein color filters are formed on each of the first through the fourth light-receiving elements forming a color combination unit and the color filters of the same color are formed on respective light-receiving elements where charges generated in each of the respective light-receiving elements are transferred in the same direction. The pixel regions having color filters of the same color, are separated by a substantially uniform distance from one another.

### CROSS-REFERENCE TO RELATED PATENT APPLICATION

This application claims the benefit of Korean Patent Application No. 10-2004-0101140, filed on Dec. 3, 2004, in the Korean Intellectual Property Office, the disclosure of which is incorporated herein in its entirety by reference.

### BACKGROUND OF THE INVENTION

1. Field of the Invention

The present invention relates to an image sensor, and more particularly to a complementary metal oxide semiconductor (CMOS) image sensor.

2. Description of Related Art

Image sensors may be classified into charge coupled device (CCD) image sensors and complementary metal oxide semiconductor (CMOS) image sensors. Both the CCD and the CMOS image sensors convert photo energy into predetermined electrical signals. There are differences between CCD and the CMOS image sensors from the viewpoint of how charges generated from photo energy are transferred and read-out.

The CCD and the CMOS image sensors are widely used for mobile phones, digital cameras and security monitors. The CMOS image sensors are gaining popularity because the CMOS image sensors can be fabricated on one chip by using a general semiconductor process or a silicon process, in comparison with the CCD image sensors. By contrast, the CCD image sensors are fabricated through special processes, which can make it is difficult to fabricate a circuit for processing an output of the CCD image sensor on one chip. A silicon process can be used for fabricating the CCD image sensors.

The CMOS image sensors include a plurality of pixels of which each pixel includes a light-receiving element for receiving an incident light and converting it into predetermined charges, and an amplification device for receiving and amplifying the charges generated at the light-receiving elements. The plurality of the pixels are arranged in an array and the signal received from each of the pixels may be transferred to a display device by an image signal-processing circuit.

To reduce an area of a semiconductor chip needed for implementing the plurality of pixels of the CMOS image sensor, a shared structure has been developed in which certain components in a readout circuit are shared by adjacent pixels, wherein the readout circuit is used for transmitting the signal of each pixel, selecting a predetermined pixel and outputting the read-out signal. An example of the shared structure is a symmetric scheme where one floating diffusion region is shared by two opposite adjacent pixels. It can be difficult to maintain uniform electrical properties in this shared structure due to variations in the positional relationship between the light-receiving element and the output circuit in each pixel of the image sensor. For example, provided that a tilted light is incident upon the light-receiving element, an optical property at each pixel may be varied. As a result, there are differences in sensitivity, saturation capacity and the like so as to induce mosaic-typed fixed pattern noise. In addition, where a distance varies between the output circuit and each light-receiving element where the color filters of the same color are allocated, and transfer directions of electrons generated at the light-receiving element are not substantially identical to one another, a noise may be incurred. For example, the non-uniform distances between green pixels result in aliasing noise due to a non-uniform sampling.

FIG. 1 is a schematic view illustrating an arrangement of a color filter pattern and an output circuit in the CMOS image sensor having a shared structure. Referring to FIG. 1, each pixel is indicated as the color filter corresponding to each light-receiving element. These pixels are denoted as a first green pixel 10, a first red pixel 20, a first blue pixel 30, a second green pixel 40, a third green pixel 50, a fourth green pixel 60, etc. Light-receiving elements corresponding to the pixels are arranged uniformly in rows and columns so as to form a matrix. In addition, between two opposite pixels, e.g., the first red pixel 20 and the fourth green pixel 60 or the first green pixel 10 and the first blue pixel 30, shared output circuits or readout circuits are interposed, e.g., 21 and 22.

In the CMOS image sensor, one red pixel, two green pixels and one blue pixel constitute one color combination unit, e.g., 5, for detecting different color hues. A distance L1 between the first green pixel 10 and the second green pixel 40 is different from a distance L2 between the second green pixel 40 and the third green pixel 50. Since the shared output circuit 22 is disposed between the first green pixel 10 and the first blue pixel 30, the distance L1 between the first green pixel 10 and the second green pixel 40 is longer than the distance L2 between the second green pixel 40 and the third green pixel 50. Accordingly, fixed pattern noise can result from calculating the color hues, wherein the color at each position may be improperly calculated due to combinations of green with red, green and blue, wherein the distances between green pixels vary.

Electric charges generated in the first and the third green pixels 10 and 50 are transferred to the readout circuits in a first direction, i.e., a downward direction of FIG. 1. Likewise, electric charges generated in the second and the fourth green pixels 40 and 60 are transferred to the readout circuits in a second direction, i.e., an upward direction of FIG. 1. Therefore, aliasing noise can result from carrying out an ion implantation process upon the light-receiving element while a wafer is tilted, wherein the amount of the electric charges may not be uniformly generated in the light-emitting element of each pixel.

Accordingly, there is a need for a CMOS image sensor having reduced fixed pattern noise and aliasing noise.

### SUMMARY OF THE INVENTION

According to an embodiment of the present invention, a complementary metal oxide semiconductor (CMOS) image sensor includes a first array including a plurality of first rows arranged in phase in a second direction of which at least one of the first rows comprises a plurality of first pairs of light-receiving elements arranged in a first direction, wherein at least one of the first pair of the light-receiving elements comprises a first and a second light-receiving element sharing at least a first floating diffusion region disposed therebetween, and a second array including a plurality of second rows arranged in phase in the second direction of which at least one of the second rows comprises a plurality of second pairs of light-receiving elements arranged in the first direction, wherein at least one of the second pair of the light-receiving elements comprises a third and a fourth light-receiving element sharing at least a second floating diffusion region disposed therebetween, wherein color filters are formed on each of the first through the fourth light-receiving elements to form a color combination unit, wherein light-receiving elements having the same color filter formed thereon generate charges that are transferred in the same direction.

The at least one second row may be arranged to have a ½-phase difference with respect to the at least one first row arranged adjacent to the at least one second row. The color filters of the same color may be formed on the second and the fourth light-receiving elements. For example, green filters may be formed on the first and the fourth light-receiving elements.

A distance between a first light-receiving element in the at least one first row and a fourth light-receiving element in the at least one second row adjacent to the at least one first row may be substantially equal to a distance between the first light-receiving element in the at least one first row and another fourth light-receiving element in the at least one second row, wherein the fourth light-receiving element is adjacent to another fourth light-receiving element in the at least one second row. The light-receiving element comprises a photodiode or a photogate formed in a semiconductor substrate.

The at least one first pair of the light-receiving elements and the at least one second pair of the light-receiving elements each share at least one respective element of the output circuit, e.g., a transfer gate, a reset gate, a row select gate and an amplifier.

According to an embodiment of the present invention, a CMOS image sensor includes a first array including a plurality of first rows arranged in phase in a second direction of which at least one of the first rows comprises a plurality of first pairs of light-receiving elements arranged in a first direction, wherein at least one of the first pair of the light-receiving elements comprises a first and a second light-receiving element sharing at least one element of an output circuit disposed therebetween, and a second array including a plurality of second rows arranged in phase in a second direction of which at least one of the second rows comprises a plurality of second pair of light-receiving elements arranged in a first direction, wherein the at least one second pair of the light-receiving elements comprises a third and a fourth light-receiving element sharing at least one element of the output circuit disposed therebetween, wherein the at least one second row has a ½-phase difference with respect to the at least one first row arranged adjacent to the at least one second row.

Color filters are formed on each of the first through the fourth light-receiving elements to form a color combination unit, wherein light-receiving elements having the same color formed thereon generate charges that are transferred in the same direction. For instance, green color filters are formed on the second and the fourth light-receiving elements.

A distance between a first light-receiving element in the at least one first row and a fourth light-receiving element in the at least one second row adjacent to the at least one first row is substantially equal to a distance between the first light-receiving element in the at least one first row and another fourth light-receiving element in the at least one second row, the fourth light-receiving element being adjacent to another fourth light-receiving element in the at least one second row. The light-receiving element comprises a photodiode or a photogate formed in a semiconductor substrate.

The at least one first pair of the light-receiving elements and the at least one second pair of the light-receiving elements each respectively share one or more of a transfer gate, a reset gate, a row select gate and an amplifier.

### BRIEF DESCRIPTION OF THE DRAWINGS

The present invention will become more apparent by describing in detail exemplary embodiments thereof with reference to the attached drawings in which:

FIG. 1 is a schematic view illustrating arrangements of a color filter pattern and output circuits in the complementary metal oxide semiconductor (CMOS) image sensor;

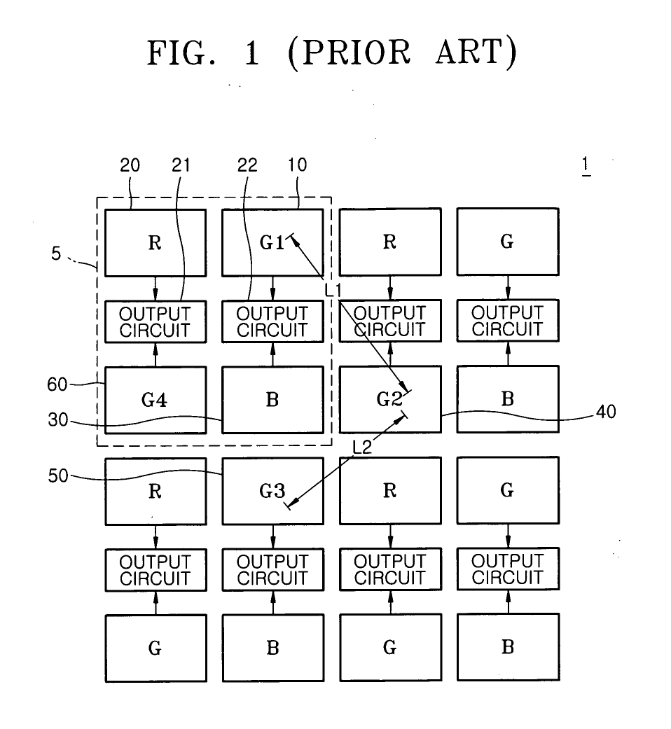

FIG. 2 is a schematic view illustrating arrangements of a color filter pattern and output circuits in a CMOS image sensor according to an embodiment of the present invention;

FIG. 3 is a planar view of the output circuit disposed between a light-receiving element and an adjacent light-receiving element in a pixel array, each light-receiving element existing under each color filter of FIG. 2; and

FIG. 4 is a detailed planar view of two adjacent light-receiving elements and the output circuit disposed therebetween illustrated in FIG. 3.

### DETAILED DESCRIPTION OF PREFERRED EMBODIMENTS

The present invention will now be described more fully with reference to the accompanying drawings, in which exemplary embodiments of the invention are shown. The present invention may, however, be embodied in many different forms and should not be construed as being limited to embodiments set forth herein; rather, embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements.

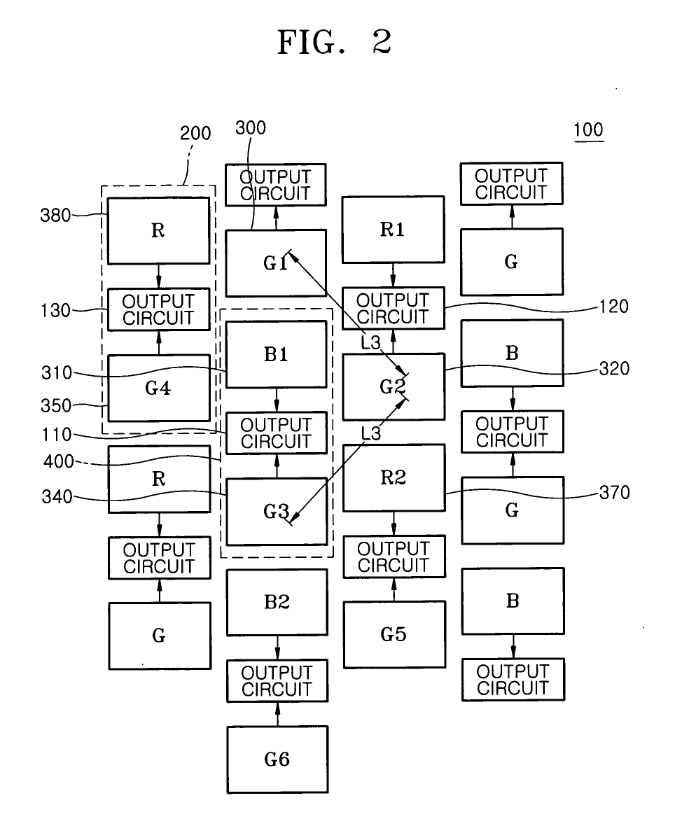

FIG. 2 is a schematic view illustrating an arrangement of light-receiving elements and shared output circuits in a CMOS image sensor according to an embodiment of the present invention. The light-receiving elements are components of pixels where color filters are allocated. In detail, FIG. 2 illustrates a Bayer color filter array for detecting an image signal as a combination of red, green and blue color. Each red pixel region includes a red filter, each green pixel region includes a green color filter and each blue color filter region includes a blue color filter.

Referring to FIG. 2, one red pixel region 380, two green pixel regions 340 and 350, and one blue pixel region 310 constitute one color combination set for determining colors of incident light. The red pixel region 380 and a fourth green pixel region 350 share an output circuit 130 disposed therebetween. The output circuit 130 is disposed in a first direction, i.e., a longitudinal direction of FIG. 2. The red pixel region 380, the fourth green pixel region 350 and the output circuit 130 comprises a first pair 200 of the red and the fourth green pixel regions 380 and 350 having a symmetrical structure (Hereinafter, referred to as ‘first pair 200’). A plurality of first pairs 200 are formed in the first direction forming a first row(Hereinafter, referred to as ‘first row’). A plurality of first rows are formed in phase in a second direction perpendicular to the first direction, i.e., a transverse direction of FIG. 2, forming a first array of red and green pixel regions in a shape of a matrix (Hereinafter, referred to as ‘first array’), wherein each first row is uniformly separated by a predetermined distance from adjacent first rows.

At a row adjacent to the first array, a blue pixel region 310 and a third green pixel region 350 share an output circuit 110 disposed therebetween. The blue pixel region 310, the third green pixel region 350 and the output circuit 110 form a second pair 400, wherein the blue and the third green pixel regions 310 and 340 have a symmetrical structure (Hereinafter, referred to as ‘second pair 400’). In the first direction, a plurality of second pairs 400 are formed. The plurality of second pairs 400 form a second row of the blue and the third green pixel regions 310 and 340 (Hereinafter, referred to as ‘second row’). A plurality of second rows are formed repeatedly in phase in the second direction perpendicular to the first direction, forming a second array of the blue and the third green pixel regions 310 and 340 in a shape of a matrix (Hereinafter, referred to as ‘second array’), wherein each second row is uniformly separated by a predetermined distance from adjacent second rows. Each of the second rows is interposed between adjacent first rows, whereby the first arrays and the second arrays are interlaced to constitute a CMOS image sensor.

According to an embodiment of the present invention, the first and the second arrays and are interlaced in the CMOS image sensor having a ½-phase difference therebetween. Each pair of corresponding first pair 200 and second pair 400 constitute one color combination unit. Since the first and the second arrays and are interlaced in the CMOS image sensor having ½-phase difference therebetween, distances between one green pixel region in one of the first and the second rows and green pixel regions disposed in adjacent rows are substantially equal to each other, which is denoted as distance L3 in FIG. 2. That is, a distance between a first green pixel region 300 and a second green pixel region 320 becomes substantially equal to a distance between the second green pixel region 320 and the third green pixel region 340.

In addition, electric charges generated in the pixels where the color filters of the same color are arranged, are transferred to the output circuit in the same direction. The first pair 200 and the second pair 400 constitute one color combination unit and the electric charges generated in the fourth and the third green pixel regions 350 and 340 by an incident light move into the output circuits 130 and 110 respectively in the same direction, i.e., an upward direction of FIG. 2. The green color filters are arranged in both the fourth and the third green pixel regions 350 and 340. The electric charges generated at the light-receiving element of the fourth green pixel region 350 are transferred in the upward direction to the output circuit 130 of the first pair 200. Likewise, the electric charges generated at the light-receiving element of the third green pixel region 340 are transferred in the upward direction to the output circuit 110 of the second pair 400. Even in a case where a tilted light is incident on the green pixel regions of one color combination unit having the first pair 200 and the second pair 400 in the CMOS image sensor, it is possible to maintain uniform electrical and optical properties of each green pixel region, wherein distances between green pixel regions are substantially equal.

Image distortion caused by different distances between pixels can be substantially prevented. A layout of the green pixel regions and the output circuits enables the charges generated in the green pixel regions to move in the same direction. The layout reduces differences in the electrical and optical properties between the green pixel regions. According to an embodiment of the present invention, it is possible to reduce the property differences of the adjacent pixel regions which vary with a direction of the electric charge under a transfer gate transferring the electric charge between the pixel regions where the same color filters are formed. Although FIG. 2 illustrates output circuits shared by two symmetrical pixel regions, the output circuits may be shared with more than two pixel regions, for example, the output circuits may be shared with four or six pixel regions.

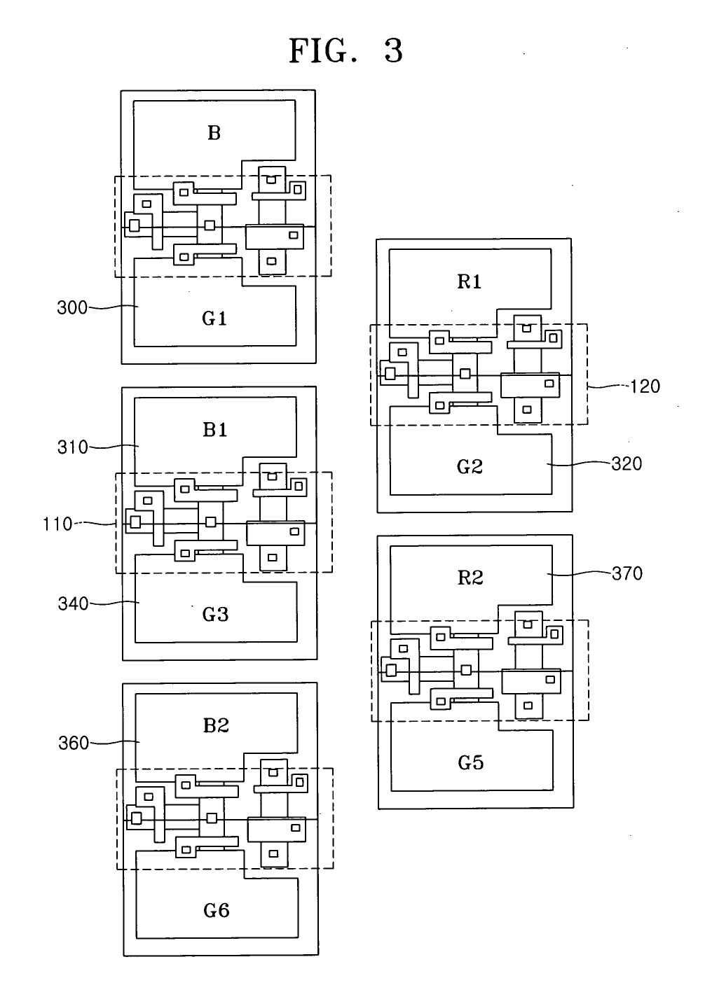

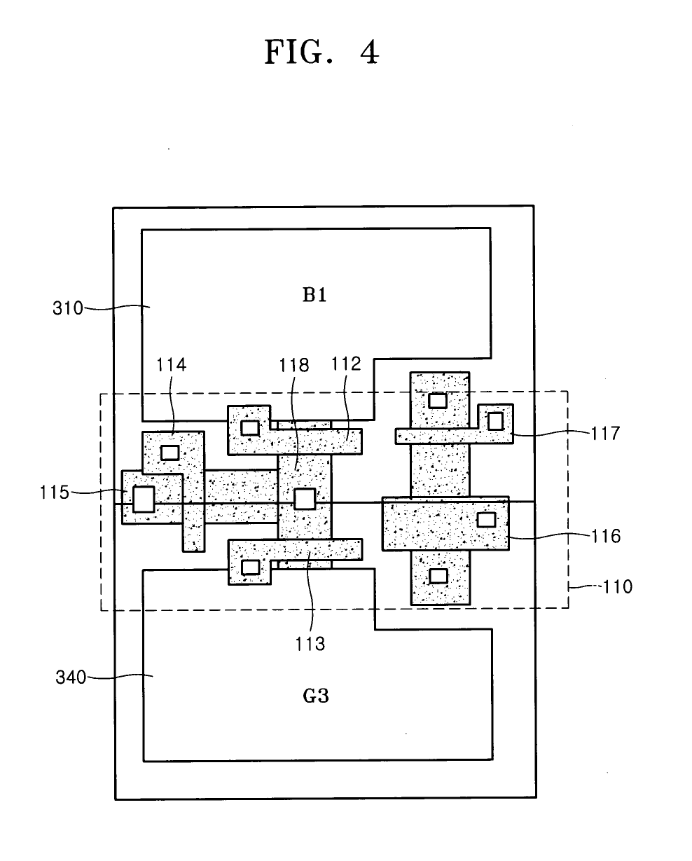

FIG. 3 is a planar view illustrating an output circuit disposed between adjacent light-receiving elements, which are disposed under each color filter of FIG. 2. FIG. 4 is a detailed planar view of two light-receiving elements and the output circuit disposed therebetween illustrated in FIG. 3.

Referring to FIGS. 3 and 4, a layout includes a pair of pixel regions that share a floating diffusion region therebetween, wherein one pixel region is symmetrically opposite to the other pixel region with respect to the floating diffusion region. The light-receiving element of each pixel region is an active region of a semiconductor substrate in which impurities are implanted. An isolation region is disposed between these pixel regions sharing the output circuit. In each pixel region, which is formed in the semiconductor substrate, there are formed light-receiving elements, e.g., 310 and 340. Each light-receiving element comprises, for example, a photodiode or a photogate for converting incident light into a predetermined electric charge.

In FIG. 4, a first light-receiving element 310 and a second light-receiving element 340 are arranged in the CMOS image sensor sharing an output circuit 110 interposed therebetween, wherein a blue color filter is disposed over the first light-receiving element 310 and a green color filter is disposed over the second light-receiving element 340. The electric charge generated in the first light-receiving element 310 is transferred into a floating diffusion region 118 of the output circuit 110 by a first transfer gate 112. Likewise, the electric charge generated in the second light-receiving element 340 is transferred into the floating diffusion region 118 of the output circuit 110 by a second transfer gate 113.

The output circuit 110 shared by the first and the second light-receiving elements 310 and 340 may be designed in various shapes according to a kind of the CMOS image sensor. In FIG. 4, the output circuit 110 comprises transfer gates 112 and 113, a shared floating diffusion region 118, a reset gate 114, a power voltage 115, a source follow gate 116 and a row select gate 117. At the first and the second light-receiving elements 310 and 340, an optical integrator, such as a photodiode and a photogate, is formed to convert the light into an electric charge. The generated electric charge is transferred into the floating diffusion region 118 by operation of the transfer gates 112 and 113. The transfer gates may be formed of polysilicon.

The floating diffusion region 118, the source follow gate 116 or the reset gate 114 may be shared by adjacent pixel regions of the output circuit 110. It is preferable that the floating diffusion region 118, the source follow gate 116 and the reset gate 114 may be shared to reduce the area of a semiconductor chip.

The electric charge transferred into the floating diffusion region turns on the reset gate, electrically connecting the reset gate to the power voltage and resetting the charges. Thereafter, the reset gate is turned off and the transfer gate is turned on to transfer the electric charge generated in the light-receiving element into the floating diffusion region. A voltage difference is determined by subtracting a voltage of the electric charge accumulated in the floating region by turning on the transfer gate from a voltage of the electric charge for turning on the reset gate. The voltage difference is transmitted as a signal into an analog-to-digital converter (ADC). Although the image sensor comprises a color filter pattern incorporating therein a color combination unit configured with blue, green and red color, it is possible to use another color combination unit, for example, configured with magenta, cyan and yellow. The transfer gate, the reset gate and the source follow gate may be formed of polysilicon. The photodiode in each pixel region may be formed in a shape of a pinned photodiode so that electrons may be accumulated in an n-typed region. In the floating diffusion region, n-type dopant may be ion-implanted. Over a region of each pixel, color filters formed of a resin and a microlens are formed on the color filter for collecting the incident light into the optical integrator such as the photodiode.

Although embodiments of the present invention have been illustrated using an arrangement of red, green and the blue color filters in the Bayer pattern, embodiments may be applicable to a diagonal stripe pattern having an arrangement similar to the Bayer pattern. In addition, though a layout where two green color filters are incorporated in one color combination unit is illustrated to embody natural color, other color combination units may have two of the same color filters, e.g., blue or red, as well as green color. Furthermore, the output circuit may be varied with a kind of the CMOS image sensor.

According to an embodiment of the present invention, since the electric charges generated in the light-receiving elements where the color filters of the same color filter are allocated in one color combination unit are transferred in the same direction, it is possible to maintain uniform electrical and optical properties in each pixel of the CMOS image sensor, to thereby reduce a mosaic-typed fixed noise pattern.

Moreover, according to an embodiment of the present invention, the light-receiving elements where the color filters of the same color filter are arranged in one color combination unit, are uniformly separated by a predetermined distance so that a spatial sampling is done uniformly reducing an aliasing noise.

While the present invention has been particularly shown and described with reference to exemplary embodiments thereof, it will be understood by those of ordinary skill in the art that various changes in form and details may be made therein without departing from the spirit and scope of the present invention.

What is claimed is:

1. A CMOS (complementary metal oxide semiconductor) image sensor comprising:
a first array including a plurality of first rows arranged in phase in a second direction of which at least one of first rows comprises a plurality of first pairs of light-receiving elements arranged in a first direction, wherein at least one of the first pairs of the light-receiving elements comprises a first and a second light-receiving element sharing at least a first floating diffusion region disposed therebetween; and
a second array including a plurality of second rows arranged in phase in the second direction of which at least one of second rows comprises a plurality of second pairs of light-receiving elements arranged in the first direction, wherein at least one of the second pairs of the light-receiving elements comprises a third and a fourth light-receiving element sharing at least a second floating diffusion region disposed therebetween,
wherein color filters are formed on each of the first through the fourth light-receiving elements to form a color combination unit, wherein light-receiving elements having the same color filter formed thereon generate electrical charges that are transferred in substantially the same direction.

2. The CMOS image sensor of claim 1, wherein the at least one second row has a ½-phase difference with respect to the at least one first row arranged adjacent to the at least one second row.

3. The CMOS image sensor of claim 1, wherein the color filters of the same color are formed on the second and the fourth light-receiving elements.

4. The CMOS image sensor of claim 1, wherein the color filters of the same color are green filters.

5. The CMOS image sensor of claim 3, wherein a distance between a first light-receiving element in the at least one first row and a fourth light-receiving element in the at least one second row adjacent to the at least one first row is substantially equal to a distance between the first light-receiving element in the at least one first row and another fourth light-receiving element in the at least one second row, the fourth light-receiving element being adjacent to said another fourth light-receiving element in the at least one second row.

6. The CMOS image sensor of claim 1, wherein the light-receiving element comprises a photodiode or a photogate formed in a semiconductor substrate.

7. The CMOS image sensor of claim 1, wherein the at least one first pair of the light-receiving elements and the at least one second pair of the light-receiving elements each respectively share one or more of a transfer gate, a reset gate, a row select gate and an amplifier.

8. A CMOS (complementary metal oxide semiconductor) image sensor comprising:
a first array including a plurality of first rows arranged in phase in a second direction of which at least one of the first rows comprises a plurality of first pairs of light-receiving elements arranged in a first direction, wherein at least one of the first pairs of the light-receiving elements comprises a first and a second light-receiving element sharing at least one element of an output circuit disposed therebetween; and
a second array including a plurality of second rows arranged in phase in a second direction of which at least one of the second rows comprises a plurality of second pairs of light-receiving elements arranged in a first direction, wherein at least one of the second pairs of the light-receiving elements comprises a third and a fourth light-receiving element sharing at least one element of the output circuit disposed therebetween,
wherein the at least one second row has a ½-phase difference with respect to the at least one first row arranged adjacent to the at least one second row.

9. The CMOS image sensor of claim 8, wherein color filters are formed on each of the first through the fourth light-receiving elements to form a color combination unit, wherein a pair of the light-receiving elements having the same color filter formed thereon generate electric charges that are transferred in the same direction.

10. The CMOS image sensor of claim 10, wherein the color filters of the same color are formed on the second and the fourth light-receiving elements.

11. The CMOS image sensor of claim 10, wherein the color filters of the same color are green filters.

12. The CMOS image sensor of claim 8, wherein a distance between a first light-receiving element in the at least one first row and a fourth light-receiving element in the at least one second row adjacent to the at least one first row is substantially equal to a distance between the first light-receiving element in the at least one first row and another fourth light-receiving element in the at least one second row, the fourth light-receiving element being adjacent to said another fourth light-receiving element in the at least one second row.

13. The CMOS image sensor of claim 8, wherein the light-receiving element comprises a photodiode or a photogate formed in a semiconductor substrate.

14. The CMOS image sensor of claim 8, wherein the at least one first pair of the light-receiving elements and the at least one second pair of the light-receiving elements each respectively share one or more of a transfer gate, a reset gate, a row select gate and an amplifier.

15. A CMOS (complementary metal oxide semiconductor) image sensor comprising:
a color combination unit provided with a first red pixel region, a first green pixel region, a second green pixel region and a first blue pixel region; and
a plurality of output circuits each having a transfer gate, each output circuit being shared by at least two pixel regions among the pixel regions,
wherein charges generated in the first and the second green pixel regions are transferred in a first direction through respective transfer gates in the color combination unit.

16. The CMOS image sensor of claim 15, wherein the plurality of output circuits each include a floating diffusion region shared by at least two pixel regions among the pixel regions.

17. The CMOS image sensor of claim 15, wherein the plurality of output circuits each include a source follow gate shared by at least two pixel regions among the pixel regions.

18. The CMOS image sensor of claim 15, wherein the plurality of output circuits each include a reset gate shared by at least two pixel regions among the pixel regions.

19. The CMOS image sensor of claim 15, wherein the first red pixel region and the first green pixel region are symmetrically arranged to each other across a corresponding output circuit.
